(19) United States
(12) Patent Application Publication
(10) Pub. No.: US 2011/0195189 A1
(43) Pub. Date: Aug. 11, 2011

(54) PATTERN FORMATION METHOD

(76) Inventor: Yoshihisa KAWAMURA, Kanagawa-ken (JP)

(21) Appl. No.: 12/974,946

(22) Filed: Dec. 21, 2010

(30) Foreign Application Priority Data
Feb. 9, 2010 (JP) 2010-26400

(51) Int. Cl. B05D 1/32

(52) U.S. Cl. 427/259

(57) ABSTRACT

According to one embodiment, a pattern formation method is disclosed. The method includes applying an imprint material onto a workpiece film; and bringing a transfer surface having a first unevenness of a template into contact with the imprint material to form a second unevenness in the imprint material. The second unevenness reflects a configuration of the first unevenness. The method includes curing the imprint material; filling a mask material into a recess of the second unevenness of the cured imprint material; exposing a part of the workpiece film by using the filled mask material as a mask to pattern the imprint material; and patterning the workpiece film by using the patterned imprint material as a mask. A thickness of the imprint material between the workpiece film and a bottom face of the recess of the second unevenness is not less than 2.5 times a half pitch of the second unevenness.

### CROSS-REFERENCE TO RELATED APPLICATIONS

This application is based upon and claims the benefit of priority from the prior Japanese Patent Application No. 2010-026400, filed on Feb. 9, 2010; the entire contents of which are incorporated herein by reference.

### FIELD

Embodiments described herein relate generally to a pattern formation method.

### BACKGROUND

Nanoimprinting used to transfer an unevenness of a template onto a substrate is drawing attention as a technology to form ultra-fine patterns with high productivity when manufacturing electronic devices having ultra-fine structures such as semiconductor devices, MEMS (Micro Electro Mechanical System) devices, etc.

During nanoimprinting, an unevenness pattern is transferred onto a resin on the substrate by bringing the template having the unevenness pattern to be transferred into contact with the resin on the substrate and by curing the resin in a state in which the resin conforms to the configuration of the unevenness pattern of the template.

During nanoimprinting, in the case where the aspect ratio of the unevenness of the template is high, stress may concentrate in a part of the resin and defects in which the transfer pattern of the resin is destroyed may occur when template separation is performed to remove the template from the resin.

In the case where particles exist on the substrate during conventional nanoimprinting, the template pattern is destroyed when the template contacts the substrate; defects occur; and the template life may undesirably decrease.

“Process-Step and Flash Imprint Lithography (S-FIL) Technology,” online, searched Dec. 21, 2009, internet <URL: http://sfil.org/Technology/etch.html> discusses a method in which a planarization layer is provided on a substrate; an imprint resist is applied thereon; and the planarization layer is patterned using the imprint resist as a mask. In the case where particles exist in such a method as well, the particles cause destruction of the template pattern, the occurrence of defects, and a decrease of the template life.

### BRIEF DESCRIPTION OF THE DRAWINGS

FIG. 1 is a flowchart illustrating a pattern formation method according to an embodiment;

FIGS. 2A to 2D are schematic cross-sectional views in order of the processes, illustrating the pattern formation method according to the embodiment;

FIGS. 3A to 3D are schematic cross-sectional views in order of the processes, illustrating the pattern formation method according to the embodiment;

FIG. 4 is a schematic cross-sectional view illustrating the state of the process of a part of the pattern formation method according to the embodiment;

FIGS. 5A to 5D are schematic cross-sectional views in order of the processes, illustrating a pattern formation method of a first comparative example;

FIGS. 6A and 6B are schematic cross-sectional views in order of the processes, illustrating the pattern formation method of the first comparative example;

FIGS. 7A to 7C are schematic cross-sectional views illustrating the state of the process of a part of the pattern formation method of the first comparative example;

FIGS. 8A to 8D are schematic cross-sectional views in order of the processes, illustrating a pattern formation method of a second comparative example;

FIGS. 9A and 9B are schematic cross-sectional views in order of the processes, illustrating the pattern formation method of the second comparative example;

FIGS. 10A and 10B are schematic cross-sectional views illustrating the state of the process of a part of the pattern formation method of the second comparative example; and

FIGS. 11A to 11C are schematic cross-sectional views illustrating the state of the process of a part of the pattern formation method of the second example.

### DETAILED DESCRIPTION

In general, according to one embodiment, a pattern formation method is disclosed. The method can include applying an imprint material onto a workpiece film. The method can include bringing a transfer surface having a first unevenness of a template into contact with the imprint material to form a second unevenness in the imprint material. The second unevenness reflects a configuration of the first unevenness. The method can include curing the imprint material in a state of the template contacting the imprint material. The method can include filling a mask material into a recess of the second unevenness of the cured imprint material. The method can include exposing a part of the workpiece film by using the filled mask material as a mask to pattern the imprint material. In addition, the method can include patterning the workpiece film by using the patterned imprint material as a mask. A thickness of the imprint material between the workpiece film and a bottom face of the recess of the second unevenness is not less than 2.5 times a half pitch of the second unevenness.

Embodiments of the invention will now be described with reference to the drawings.

The drawings are schematic or conceptual; and the relationships between the thickness and width of portions, the proportional coefficients of sizes among portions, etc., are not necessarily the same as the actual values thereof. Further, the dimensions and the proportional coefficients may be illustrated differently among the drawings, even for identical portions.

In the specification and the drawings of the application, components similar to those described in regard to a drawing thereinabove are marked with like reference numerals, and a detailed description is omitted as appropriate.

### EMBODIMENTS

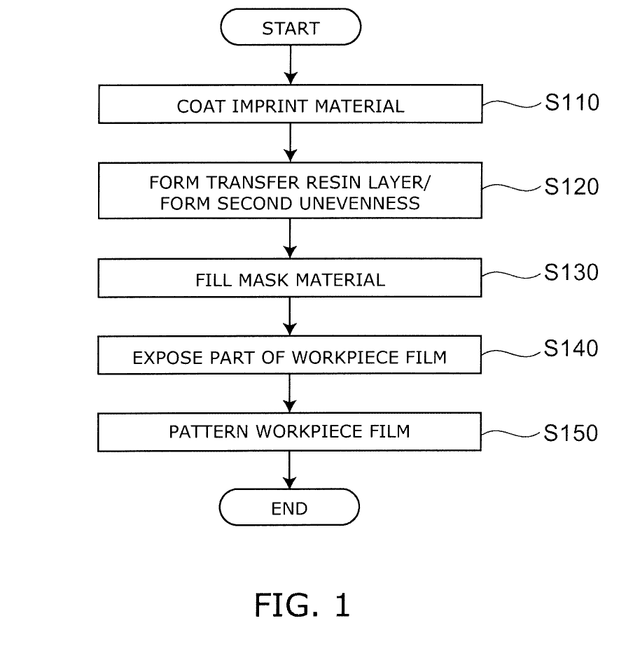

FIG. 1 is a flowchart illustrating a pattern formation method according to an embodiment of the invention.

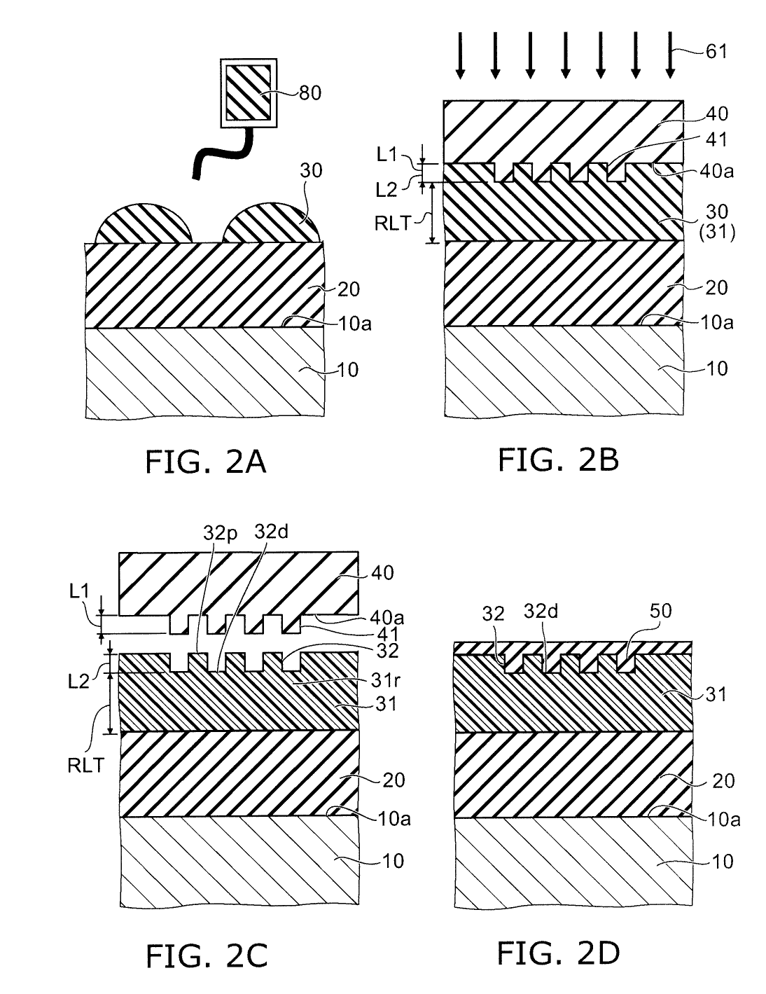

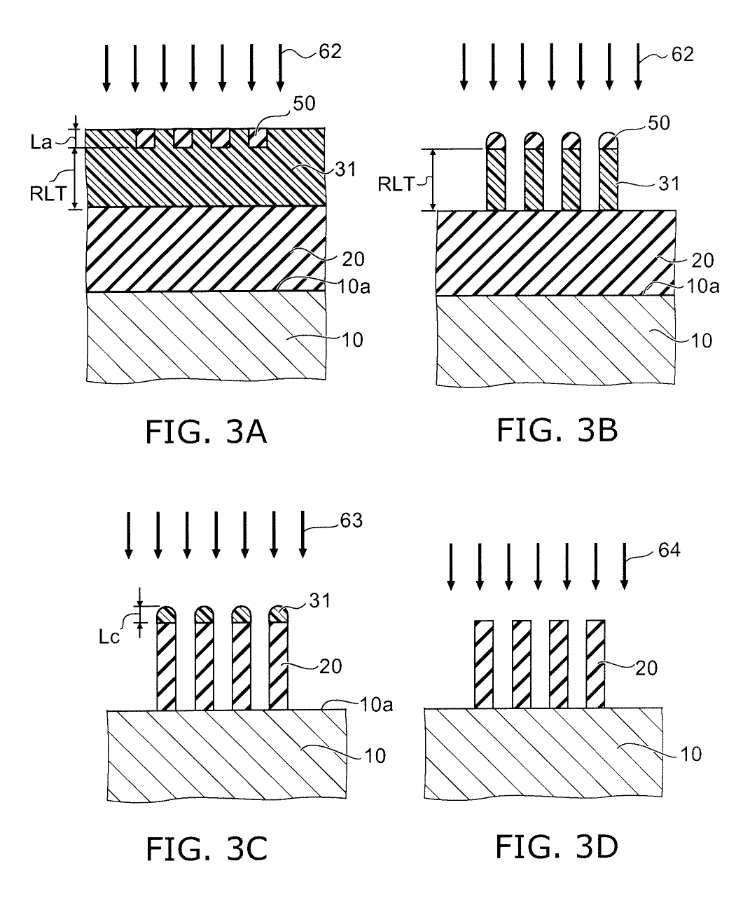

FIGS. 2A to 2D and FIGS. 3A to 3D are schematic cross-sectional views in order of the processes, illustrating the pattern formation method according to this embodiment of the invention.

In the pattern formation method according to this embodiment of the invention as illustrated in FIG. 1 and FIG. 2A, first, an imprint material is applied onto a workpiece film 20 provided on a major surface 10a of a substrate 10 (step S110). For example, a resin film 30 is formed as the imprint material on the workpiece film 20.

The substrate 10 may include any substrate such as, for example, a silicon substrate, a quartz substrate, etc.

The workpiece film 20 is a film to be patterned by the pattern formation method according to this embodiment. The workpiece film 20 may include any film such as, for example, an insulating film, a conductive film, a semiconductor film, etc. The workpiece film 20 may include, for example, metal films, films including silicon such as silicon oxide films, etc.

The resin film 30 may include, for example, a photocurable resin. In other words, the resin film 30 may include an organic film including carbon, etc. The applying of the resin film 30 onto the workpiece film 20 may include, for example, using a dispenser 80 and the like. The resin film 30 is not limited to a photocurable resin and may be a thermosetting resin.

Then, as illustrated in FIG. 1 and FIG. 2B, a transfer surface 40a of a template 40 is brought into contact with the resin film 30, where a first unevenness 41 is provided in the transfer surface 40a.

The template 40 may include, for example, quartz. An unevenness (the first unevenness 41) having the desired dimensions is provided in the transfer surface 40a of the template 40. In the case where the resin film 30 includes a thermosetting resin, it is favorable for the template 40 to include a material having excellent thermal conductivity.

By bringing the transfer surface 40a of the template 40 into contact with the resin film 30, the resin film 30 is filled into recesses of the first unevenness 41 of the template 40. Thereby, the configuration of the resin film 30 deforms to conform to the configuration of the first unevenness 41 of the template 40, that is, the first unevenness 41 is transferred onto the resin film 30. The resin film 30 is cured in this state. For example, ultraviolet rays 61 are irradiated onto the resin film 30 via the template 40. Thereby, a transfer resin layer 31 having a second unevenness 32 reflecting the configuration of the first unevenness 41 of the template 40 is formed (step S120). In other words, the second unevenness 32 that reflects the configuration of the first unevenness 41 is formed in the imprint material by bringing the transfer surface 40a of the template 40, in which the first unevenness 41 is provided, into contact with the imprint material. Then, the imprint material is cured in the state in which the template 40 contacts the imprint material.

Subsequently, as illustrated in FIG. 2C, template separation is performed by separating the template 40 and the transfer resin layer 31.

Herein, as illustrated in FIG. 2B and FIG. 2C, the depth (the height) of the first unevenness 41 of the template 40 is taken as a first unevenness depth L1. The first unevenness depth L1 is the distance from the bottom face of the recess to the upper face of the protrusion of the first unevenness 41 of the template 40.

The depth of the second unevenness 32 formed in the transfer resin layer 31 is taken as a second unevenness depth L2. The second unevenness depth L2 is the distance between the bottom face of a recess 32d and the upper face of a protrusion 32p of the second unevenness 32 of the transfer resin layer 31. Because the second unevenness 32 reflects the configuration of the first unevenness 41, the second unevenness depth L2 is substantially the same as the first unevenness depth L1.

The portion of the transfer resin layer 31 between the workpiece film 20 and the bottom face of the recess 32d of the second unevenness 32 is taken as a residual layer 31r. The residual layer thickness (RLT), that is, the thickness of the residual layer 31r (i.e., the residual layer 31r of the transfer resin layer 31 formed by bringing the template 40 into contact with the resin film 30, transferring the unevenness of the template 40 onto the resin film 30, and curing the resin film 30), is the distance between the workpiece film 20 and the bottom face of the recess 32d of the second unevenness 32 of the transfer resin layer 31 (the film thickness of the imprint material).

Then, as illustrated in FIG. 1 and FIG. 2D, a mask material 50 is filled into the recess 32d of the second unevenness 32 of the transfer resin layer 31 (step S130). In other words, the mask material 50 is filled into the recess 32d of the second unevenness 32 of the cured imprint material.

The mask material 50 may include, for example, SOG (Spin On Glass). Thereby, the mask material 50 is filled into the recess 32d of the second unevenness 32 of the transfer resin layer 31 with good fillability. Further, the planarity of the surface of the mask material 50 is good. Herein, a material having an etching rate lower than that of the transfer resin layer 31 is selected as the mask material 50.

Subsequently, CMP (Chemical Mechanical Polishing) is performed as necessary. Thereby, the surface of the transfer resin layer 31 and the mask material 50 is flattened.

Subsequently, as illustrated in FIG. 1, FIG. 3A, and FIG. 3B, a part of the workpiece film 20 is exposed by patterning the transfer resin layer 31 (the imprint material) using the filled mask material 50 as a mask (step S140).

In other words, as illustrated in FIG. 3A, the transfer resin layer 31 is patterned, for example, by RIE (Reactive Ion Etching) using the mask material 50 as a mask.

Thereby, as illustrated in FIG. 3B, the portions of the transfer resin layer 31 covered with the mask material 50 remain; and the portions of the transfer resin layer 31 not covered with the mask material 50 are removed. Generally, it is difficult to form a pattern having a high aspect ratio using imprinting in which defects easily occur during the template separation. However, by the processes recited above, imprinting can be used to transfer a pattern having a high aspect ratio onto an imprint resist.

Ions 62 used in such RIE may include, for example, ions that etch the transfer resin layer 31 which includes an organic resin.

At this time, the film thickness of the mask material 50 may be reduced somewhat.

Subsequently, as illustrated in FIG. 1 and FIG. 3C, the exposed workpiece film 20 is patterned using the patterned transfer resin layer 31 (the imprint material) as a mask (step S150).

The patterning of the workpiece film 20 may include, for example, RIE. At this time, ions 63 of such RIE may include ions that etch the workpiece film 20.

For example, as illustrated in FIG. 3B, the mask material 50 exists on the transfer resin layer 31 in the initial stage of the patterning. Then, the mask material 50 may be removed simultaneously with the patterning of the workpiece film 20 by the RIE; and the mask material 50 may not exist in subsequent stages as illustrated in FIG. 3C. Then, the workpiece film 20 is patterned by RIE using the exposed transfer resin layer 31 as a mask.

The film thickness of the transfer resin layer 31 also is reduced by such RIE. However, the transfer resin layer 31 remains until the patterning of the workpiece film 20 is completed. In other words, when the patterning of the workpiece film 20 is completed, the transfer resin layer 31 may remain and a thickness Lc of the transfer resin layer 31 may not be 0. For example, the thickness of the transfer resin layer 31 (specifically, the residual layer thickness RLT) is set to be thicker anticipating the film thickness of the transfer resin layer 31 used as the mask being reduced by the patterning of the workpiece film 20. However, this embodiment is not limited thereto. In some cases, the transfer resin layer 31 may be removed in the final stage of the patterning of the workpiece film 20 to expose, for example, a part of the surface of the workpiece film 20. In other words, it is sufficient for the workpiece film 20 to be patterned to the desired configuration.

Subsequently, as illustrated in FIG. 3D, the transfer resin layer 31 used as the mask is removed. Such a removal may be performed using, for example, ashing by oxygen plasma 64 and the like.

Thereby, the pattern reflecting the unevenness (the first unevenness 41) of the template 40 is formed on the workpiece film 20.

Thus, the pattern formation method according to this embodiment can be applied to a pattern formation method that uses nanoimprinting to perform a pattern transfer by bringing a template having an unevenness into contact with a transfer substrate such as a wafer or by reducing the spacing therebetween to perform ultra-fine patterning during, for example, the manufacturing processes of a semiconductor apparatus.

In the pattern formation method according to this embodiment, the residual layer thickness RLT is set to be thick.

For example, the residual layer thickness RLT (the thickness of the residual layer 31r, i.e., the distance between the workpiece film 20 and the bottom face of the recess 32d of the second unevenness 32, that is, the thickness of the imprint material between the workpiece film 20 and the bottom face of the recess 32d of the second unevenness 32) is set to be greater than the second unevenness depth L2 of the second unevenness 32 of the transfer resin layer 31 (the distance between the bottom face of the recess 32d of the second unevenness 32 and the upper face of the protrusion 32p of the second unevenness 32). For example, the second unevenness depth L2 may be set to be less than about 50 nm (nanometers). At this time, the residual layer thickness RLT may be set to be not less than 50 nm; and the residual layer thickness RLT may be, for example, 100 nm.

The residual layer thickness RLT may be controlled, for example, by the amount of the resin film 30 per unit surface area dropped (applied) onto the workpiece film 20 when forming the resin film 30 in step S110. The residual layer thickness RLT also may be controlled by, for example, the pressing force between the template 40 and the substrate 10 in step S120.

Thus, the pattern formation method according to this embodiment can provide a pattern formation method having high productivity in which destruction of the template due to particles, etc., in the processes is suppressed by setting a thick residual layer thickness RLT, filling a mask material into the second unevenness 32, and using the mask material to pattern the transfer resin layer 31.

Specifically, the residual layer thickness RLT may be set to be not less than 2.5 times the half pitch (one-half of the pitch) of the second unevenness 32. In the case where the residual layer thickness RLT is small, e.g., smaller than 2.5 times the half pitch of the second unevenness 32, the template is easily destroyed by particles existing in the processes. During the process of forming the second unevenness 32, control of particles is performed according to the pitch of the second unevenness 32. The effects of the particles in the processes can be sufficiently suppressed and the destruction of the template can be suppressed practically by setting the residual layer thickness RLT to be not less than 2.5 times the half pitch of the second unevenness 32 to be formed. For example, in the case where the second unevenness 32 to be formed has a half pitch of 20 nm, the residual layer thickness RLT may be set to be not less than 50 nm. The pitch of the second unevenness 32 is the same as the pitch of the first unevenness 41.

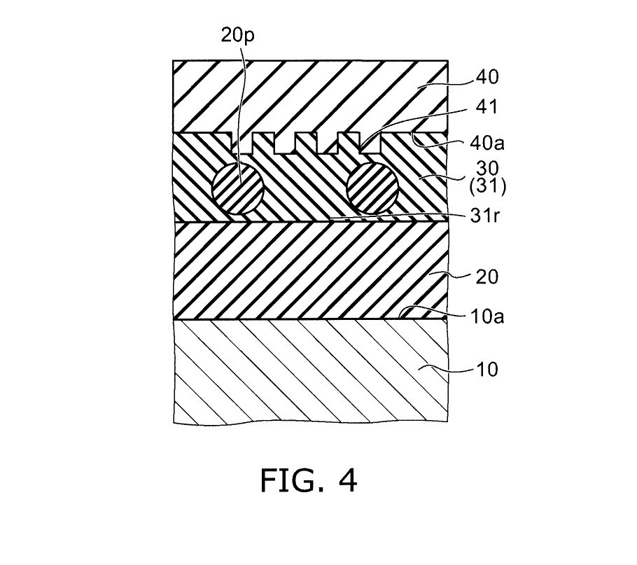

FIG. 4 is a schematic cross-sectional view illustrating the state of the process of a part of the pattern formation method according to this embodiment of the invention.

Namely, FIG. 4 corresponds to the state in which the template 40 contacts the resin film 30 in step S120 and illustrates the state in which particles 20p exist in the atmosphere of the transfer process.

In the transfer process as illustrated in FIG. 4, the particles 20p exist on the surface of the workpiece film 20 and the transfer surface 40a of the template 40. When the transfer surface 40a of the template 40 is brought into contact with the resin film 30 in such a state, the resin film 30 is filled into the recesses of the first unevenness 41 of the template 40. Then, because a sufficient amount of the resin film 30 is provided on the workpiece film 20, the particles 20p are buried in the resin film 30, and the first unevenness 41 of the template 40 is not destroyed even in the case where the particles 20p exist between the transfer surface 40a of the template 40 and the workpiece film 20.

Thus, because the thickness of the residual layer 31r of the second unevenness 32 (the residual layer thickness RLT) is thick in the pattern formation method according to this embodiment, the particles 20p are buried in the residual layer 31r and the destruction of the template 40 is suppressed.

In the case where the particle 20p has properties similar to those of the transfer resin layer 31, the particle 20p also is patterned together with the transfer resin layer 31 during the patterning (step S140) of the transfer resin layer 31 using the mask material 50 as a mask; the patterning of the workpiece film 20 is not particularly affected; and the patterning of the workpiece film 20 can be implemented to the desired state. Further, in the case where the properties of the particle 20p are different from those of the transfer resin layer 31 and the configuration of the transfer resin layer 31 becomes irregular during the patterning of the transfer resin layer 31 of step S140, the patterning of the workpiece film 20 may be affected. However, in such a case as well, negative effects on other patterning using the template 40 does not occur because only the configuration of the workpiece film 20 is irregular and the template 40 is not destroyed.

Thus, the pattern formation method according to this embodiment can provide a pattern formation method having high productivity in which the destruction of the template due to particles and the like in the processes is suppressed.

Thus, the bringing the transfer surface 40a into contact with the imprint material to form the second unevenness 32 includes burying the particle 20p in the imprint material between the workpiece film 20 and the bottom face of the recess of the second unevenness 32. The particle 20p exists in the atmosphere of the bringing the transfer surface 40a into contact with the imprint material.

Generally, during the manufacturing processes, it is difficult to remove particles having sizes smaller than 50 nm using cleaning and the like. Accordingly, there is a possibility that particles 20p smaller than 50 nm exist during the processes. By setting the residual layer thickness RLT to be not less than 50 nm, the template 40 is not destroyed even in the case where such particles 20p exist because the particles 20p are buried in the residual layer 31r. Therefore, it is desirable for the residual layer thickness RLT to be set to be not less than 50 nm.

Further, the amount of the resin film 30 (e.g., the amount per unit surface area of the workpiece film 20) is high when the template 40 is brought into contact with the resin film 30 during step S120. Thereby, the resin film 30 is easily filled into the recesses of the first unevenness 41 of the template 40 when the transfer surface 40a of the template 40 is brought into contact with the resin film 30; the transfer speed increases; and the productivity increases further. For example, gas of the atmosphere of the process (e.g., air, helium, etc.) exists in the recesses of the first unevenness 41 when the transfer surface 40a of the template 40 is brought into contact with the resin film 30. The filling of the resin film 30 into the recesses can be accelerated by introducing (for example to dissolve, to diffuse and the like) such gas of the recesses into the resin film 30 (into the imprint material).

In the case where the amount of the resin film 30 is low when the template 40 is brought into contact with the resin film 30, it takes time for the resin film 30 to fill into the recesses because the amount of the resin film 30 per the volume of the recesses is low and therefore the gas in the recesses does not dissolve easily into the resin film 30.

In the pattern formation method according to this embodiment, the gas of the recesses of the template 40 easily dissolves and/or diffuses into the resin film 30, the resin film 30 easily fills into the recesses of the template 40, the transfer speed increases, and the productivity increases further because the amount of the resin film 30 is high when the template 40 is brought into contact with the resin film 30.

Thus, the bringing the transfer surface 40a into contact with the imprint material includes introducing gas existing in the recesses of the first unevenness 41 into the imprint material.

Even in the case where differences in levels of the workpiece film 20 are large, the differences in levels can be absorbed and a stable transfer resin layer 31 can be obtained in the pattern formation method according to this embodiment because the residual layer thickness RLT is thick. As a result, the patterning of the workpiece film can be implemented with high precision.

Thus, the workpiece film 20 has a difference of levels, and the thickness of the imprint material between the workpiece film 20 and the bottom face of the recess of the second unevenness 32 is set to be larger than the height of the difference of levels.

The thickness of the residual layer thickness RLT may be set to the thickness of the transfer resin layer 31 remaining during the patterning of the workpiece film 20. In other words, in the pattern formation method according to this embodiment, the thickness of the transfer resin layer 31 that functions as the mask when patterning the workpiece film 20 is substantially the residual layer thickness RLT because the mask material 50 is separately filled into the recess 32d of the second unevenness 32 of the transfer resin layer 31 and the transfer resin layer 31 is patterned using the mask material 50. Accordingly, the thickness of the residual layer thickness RLT may be set to be the thickness of the transfer resin layer 31 remaining during the patterning of the workpiece film 20.

In other words, in the pattern formation method according to this embodiment, the thickness of the transfer resin layer 31 necessary for patterning the workpiece film 20 corresponds to the residual layer thickness RLT; and the second unevenness depth L2 of the second unevenness 32 during the transferring can be set regardless of the patterning of the workpiece film 20.

The requirements of the second unevenness depth L2 are relaxed and the aspect ratio of the second unevenness 32 can be set low because the second unevenness depth L2 of the second unevenness 32 can be set based on the conditions of the process that patterns the transfer resin layer 31 using the mask material 50. In this embodiment, the aspect ratio of the second unevenness 32 can be set to be, for example, not more than 2.5.

Thereby, the template separation of the transfer process is easy; transfer defects, for example, in which the transfer resin layer 31 remains in the recesses of the first unevenness 41 of the template 40 can be suppressed; and the productivity can be increased further.

Thus, in the pattern formation method according to this embodiment, the thickness of the residual layer 31r (the residual layer thickness RLT), which is the distance between the workpiece film 20 and the bottom face of the recess 32d of the second unevenness 32, is greater than the depth of the second unevenness 32 (the second unevenness depth L2), which is the distance between the bottom face of the recess 32d of the second unevenness 32 and the upper face of the protrusion 32p of the second unevenness 32.

The thickness of the residual layer 31r (the residual layer thickness RLT), which is the distance between the workpiece film 20 and the bottom face of the recess 32d of the second unevenness 32, is not less than 50 nm. In other words, the thickness of the residual layer 31r may be set to be not less than 2.5 times the half pitch of the second unevenness 32 in the case where the half pitch of the second unevenness 32 is about 20 nm.

The thickness of the residual layer 31r (the residual layer thickness RLT), which is the distance between the workpiece film 20 and the bottom face of the recess 32d of the second unevenness 32, may be set to be greater than the minimum value of the particle size controlled during the process in which the transfer surface 40a is brought into contact with the resin film 30.

Thereby, during the transfer process, the destruction of the template 40 due to the particles 20p and the like can be suppressed because the particles 20p and the like are buried in the residual layer 31r; and the productivity can be increased.

Because the residual layer thickness RLT is thick and the amount of the resin film 30 is high when the template 40 is brought into contact with the resin film 30, the gas of the recesses of the template 40 easily dissolves and/or diffuses into the resin film 30; the resin film 30 is easily filled into the recesses of the template 40; the transfer speed increases; and the productivity increases further.

Further, because the residual layer thickness RLT is thick, the differences in levels of the workpiece film 20 can be absorbed; a stable transfer resin layer 31 can be obtained; and the patterning of the workpiece film 20 can be implemented with high precision. Also, the aspect ratio of the first unevenness 41 of the template 40 can be low; transfer defects in which the transfer resin layer 31 remains in the recesses of the first unevenness 41 of the template 40 can be suppressed; and from these points as well, the productivity can be increased. According to this embodiment recited above, a pattern having a high aspect ratio can be formed using imprinting while suppressing defects; and the destruction of the template during the contact can be suppressed.

### First Comparative Example

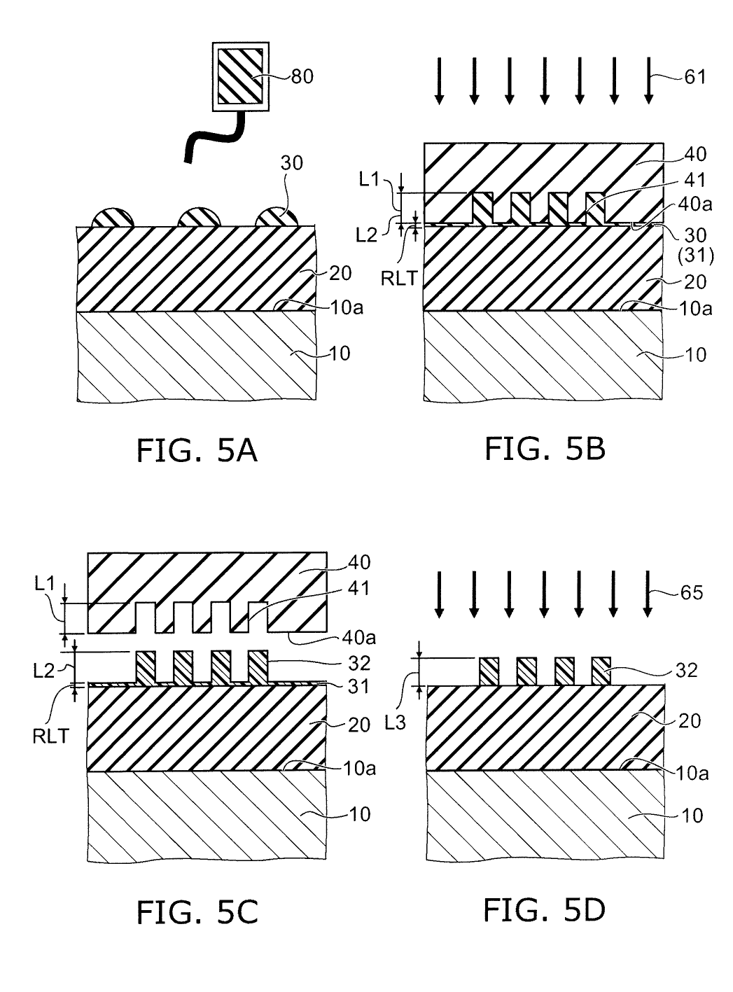

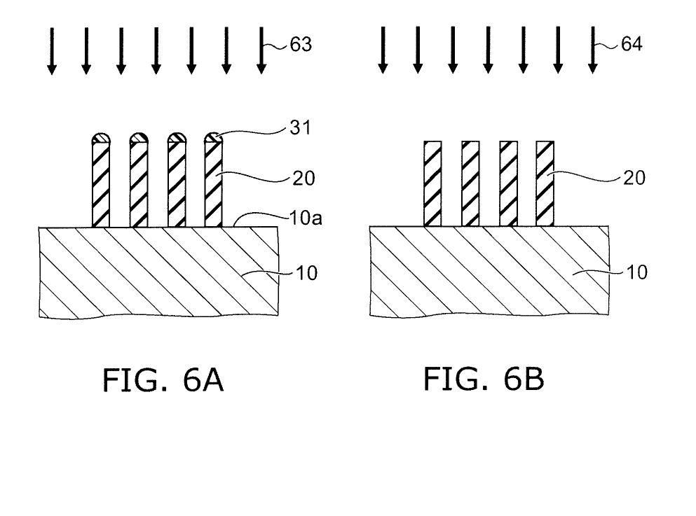

FIGS. 5A to 5D and FIGS. 6A and 6B are schematic cross-sectional views in order of the processes, illustrating a pattern formation method of a first comparative example.

The pattern formation method of the first comparative example is an example in which the second unevenness 32 of the transfer resin layer 31 itself, which is formed based on the first unevenness 41 of the template 40, is used to pattern the workpiece film 20.

As illustrated in FIG. 5A, the resin film 30 is formed on the workpiece film 20 provided on the major surface 10a of the substrate 10.

Subsequently, as illustrated in FIG. 5B, the transfer resin layer 31 having the second unevenness 32 reflecting the configuration of the first unevenness 41 is formed by bringing the transfer surface 40a of the template 40 into contact with the resin film 30, transferring the first unevenness 41 onto the resin film 30, and curing the resin film 30.

At this time, the first unevenness depth L1 of the first unevenness 41 of the template 40, i.e., the second unevenness depth L2 of the second unevenness 32 of the transfer resin layer 31, is set to be large enough that the transfer resin layer 31 can withstand the patterning of the workpiece film 20. In other words, the aspect ratio of the first unevenness 41 of the template 40 and the second unevenness 32 of the transfer resin layer 31 is high, e.g., higher than 2.5. The residual layer thickness RLT is set to be thin at this time.

The template 40 used in the pattern formation method of the first comparative example has a configuration in which the recesses and the protrusions of the template 40 used in the pattern formation method according to this embodiment are interchanged with each other.

Then, as illustrated in FIG. 5C, template separation is performed by separating the template 40 and the transfer resin layer 31.

Subsequently, as illustrated in FIG. 5D, the residual layer 31r is removed by performing, for example, anisotropic etching of the transfer resin layer 31 using RIE including oxygen 65. Thereby, a part of the surface of the workpiece film 20 is exposed. Due to the patterning margin of the anisotropic etching recited above, a depth L3 (a height) of the second unevenness 32 of the transfer resin layer 31 in this state at this time has a value, for example, slightly less than the second unevenness depth L2.

Then, as illustrated in FIG. 6A, the exposed workpiece film 20 is patterned using the transfer resin layer 31 as a mask.

Subsequently, as illustrated in FIG. 6B, the transfer resin layer 31 is removed as necessary by the oxygen plasma 64 and the like.

Thereby, the pattern based on the first unevenness 41 of the template 40 is formed in the workpiece film 20.

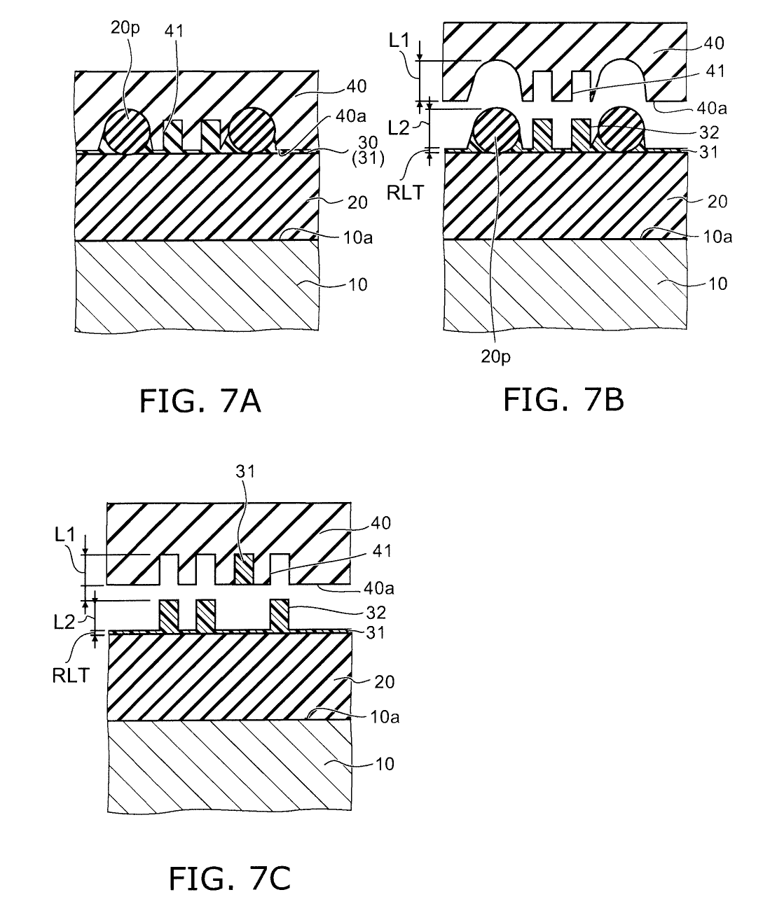

FIGS. 7A to 7C are schematic cross-sectional views illustrating the state of the process of a part of the pattern formation method of the first comparative example.

Namely, FIG. 7A and FIG. 7B correspond to the state in which the template 40 is brought into contact with the resin film 30 and the state in which template separation is performed, respectively, in the case where the particles 20p exist in the atmosphere of the transfer process. FIG. 7C corresponds to the state of a pattern defect during the template separation.

In the case where the particles 20p exist between the transfer surface 40a of the template 40 and the workpiece film 20 during the transfer process as illustrated in FIG. 7A, the particles 20p cannot be buried in the resin film 30 because the resin film 30 is thin.

Therefore, as illustrated in FIG. 7B, the first unevenness 41 of the template 40 is destroyed by the particles 20p.

Further, because it is necessary to use a high aspect ratio of the first unevenness 41, the transfer resin layer 31 remains in the recesses of the template 40 during the template separation and pattern defects of the transfer resin layer 31 occur. Then, the transfer resin layer 31 remaining in the recesses of the template 40 remains as-is during subsequent transferring; and defects occur similar to the case where the pattern of the template 40 is destroyed.

Thus, in the pattern formation method of the first comparative example, the template 40 is easily destroyed by particles; and because the aspect ratio is high, defects occur during the template separation which causes the template 40 to be destroyed.

In other words, in the pattern formation method of the first comparative example, template separation defects occur easily due to friction forces and the concentration of stress due to the deformation of the template 40 during the template separation. In ultra-fine patterns having high aspects in particular, defects during the template separation such as the pattern tearing partway, the pattern peeling from the foundation (the workpiece film 20), etc., occur easily because the tensile strength of the transfer resin layer 31 is weak. In the case where the aspect ratio of the pattern of the template 40 is limited to, for example, not more than 2.5 to prevent such defects, the transfer resin layer 31 disappears during the patterning of the workpiece film 20; and the desired patterning cannot be performed.

In nanoimprinting such as that of the first comparative example, a trade-off occurs between the pattern height at which the transfer resin layer 31 is not destroyed during the template separation and the pattern height necessary for the patterning of the workpiece film 20; and it is difficult to obtain a stable pattern formation with high productivity.

### Second Comparative Example

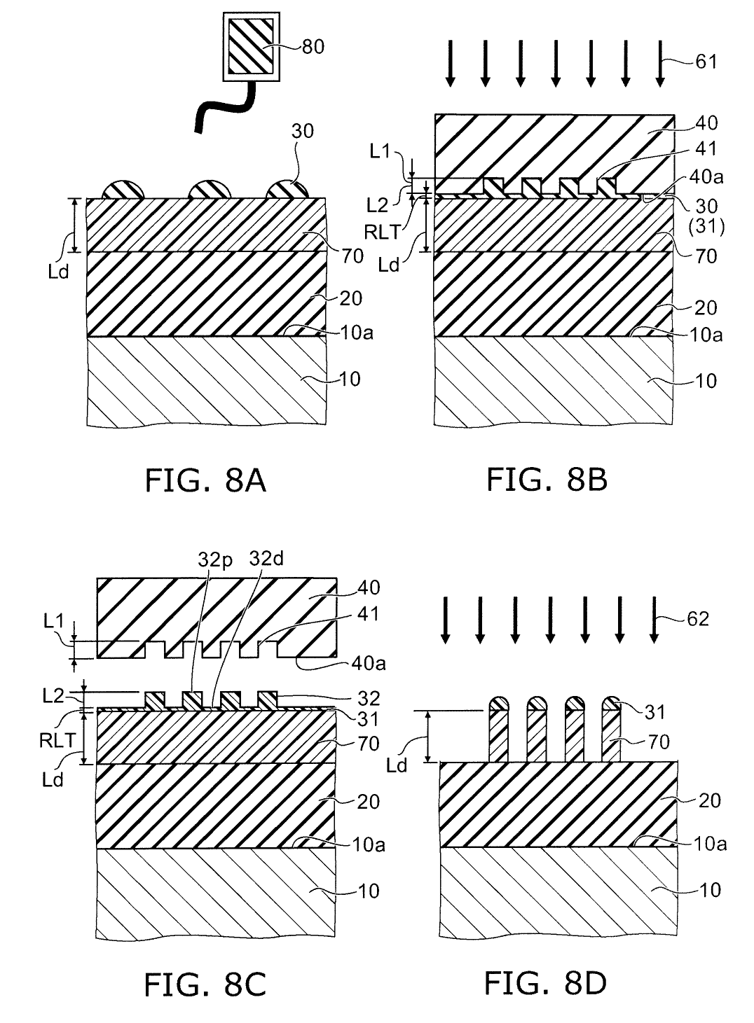

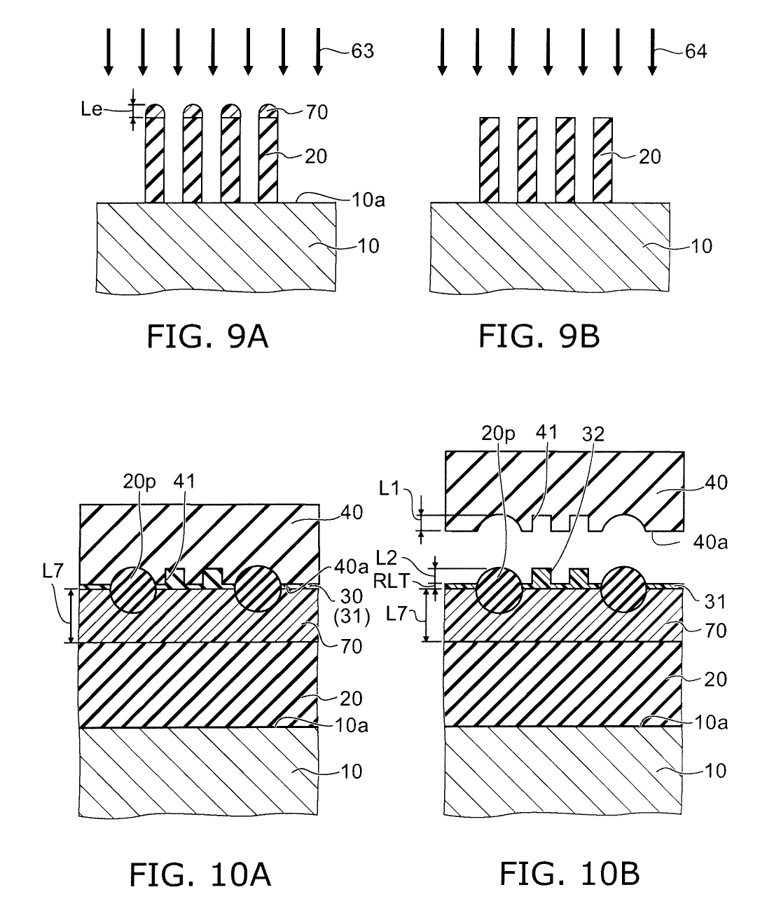

FIGS. 8A to 8D and FIGS. 9A and 9B are schematic cross-sectional views in order of the processes, illustrating a pattern formation method of a second comparative example.

In the pattern formation method of the second comparative example, a mask resin layer 70 is provided on the workpiece film 20; and the resin film 30 (the transfer resin layer 31) is provided thereon. In this example, the mask resin layer 70 is used to pattern the workpiece film 20. In other words, the pattern formation method of the second comparative example corresponds to the method recited in “Process-Step and Flash Imprint Lithography (S-FIL) Technology,” online, searched Dec. 21, 2009, internet <URL: http://sfil.org/Technology/etch.html>.

As illustrated in FIG. 8A, the mask resin layer 70 is formed on the workpiece film 20 provided on the major surface 10a of the substrate 10; and the resin film 30 is formed thereon.

The mask resin layer 70 functions as a mask when patterning the workpiece film 20. Therefore, a thickness Ld of the mask resin layer 70 is set to be thick enough that the mask resin layer 70 can withstand the patterning of the workpiece film 20.

Subsequently, as illustrated in FIG. 8B, the transfer resin layer 31 having the second unevenness 32 reflecting the configuration of the first unevenness 41 is formed by bringing the transfer surface 40a of the template 40 into contact with the resin film 30, transferring the first unevenness 41 onto the resin film 30, and curing the resin film 30.

The second unevenness 32 is used to pattern the mask resin layer 70 and may not be used to pattern the workpiece film 20. Therefore, the first unevenness depth L1 of the first unevenness 41 of the template 40, i.e., the second unevenness depth L2 of the second unevenness 32 of the transfer resin layer 31, is set to be relatively small. In other words, the aspect ratio of the first unevenness 41 of the template 40 and the second unevenness 32 of the transfer resin layer 31 is low, e.g., not more than 2.5.

In the second comparative example, the residual layer thickness RLT is set to be thin.

The template 40 used in the pattern formation method of the second comparative example has a configuration in which the recesses and the protrusions of the template 40 used in the pattern formation method according to this embodiment are interchanged with each other.

Then, as illustrated in FIG. 8C, template separation is performed by separating the template 40 and the transfer resin layer 31.

Subsequently, as illustrated in FIG. 8D, the mask resin layer 70 is patterned using the transfer resin layer 31 as a mask. Thereby, a part of the surface of the workpiece film 20 is exposed.

Then, as illustrated in FIG. 9A, the exposed workpiece film 20 is patterned using the mask resin layer 70 as a mask.

Subsequently, as illustrated in FIG. 9B, the mask resin layer 70 is removed by the oxygen plasma 64 and the like.

Thereby, the pattern based on the first unevenness 41 of the template 40 is formed in the workpiece film 20.

FIGS. 10A and 10B are schematic cross-sectional views illustrating the state of the process of a part of the pattern formation method of the second comparative example.

Namely, FIG. 10A and FIG. 10B correspond to the state in which the template 40 is brought into contact with the resin film 30 and the state in which template separation is performed, respectively, in the case where the particles 20p exist in the atmosphere of the transfer process.

In the case where the particles 20p exist between the transfer surface 40a of the template 40 and the workpiece film 20 during the transfer process as illustrated in FIG. 10A, the particles 20p cannot be buried in the resin film 30 because the resin film 30 is thin and the residual layer thickness RLT is thin.

Therefore, as illustrated in FIG. 10B, the first unevenness 41 of the template 40 is destroyed by the particles 20p.

In the second comparative example, there is a possibility that defects, in which the transfer resin layer 31 remains in the recesses of the template 40 during the template separation, can be suppressed because the second unevenness 32, i.e., the first unevenness 41, has a low aspect ratio.

Further, even in the case where the differences in levels of the workpiece film 20 are large, such differences in levels can be absorbed by the mask resin layer 70 in the pattern formation method of the second comparative example because the mask resin layer 70 is provided on the patterning film 20.

On the other hand, in the pattern formation method of the second comparative example, the amount of the resin film 30 is low because the residual layer thickness RLT is small. Therefore, the gas of the recesses does not easily dissolve into the resin film 30 when the template 40 is brought into contact with the resin film 30. Therefore, it takes time for the resin film 30 to fill into the recesses.

Thus, although it is possible to reduce the aspect ratio of the template 40, suppress the transfer defects, and reduce the effects of the differences in levels of the workpiece film 20 by providing the mask resin layer 70 in the pattern formation method of the second comparative example, the template 40 is easily destroyed by the particles 20p and it takes time to fill the resin film 30 into the recesses of the template 40 because the residual layer thickness RLT is small.

Conversely, in the pattern formation method according to this embodiment, the destruction of the template 40 due to the particles 20p and the like is suppressed and the productivity is high because the residual layer thickness RLT is thick. Also, the resin film 30 is easily filled into the recesses of the template 40; and the productivity increases further. Because the residual layer thickness RLT is thick, the differences in levels of the workpiece film 20 can be absorbed; the aspect ratio of the first unevenness 41 of the template 40 can be small; transfer defects can be suppressed; and the productivity is high.

### First Example

A pattern formation method of a first example according to this embodiment will now be described.

The workpiece film 20 is formed on the major surface 10a of the substrate 10. In this example, the workpiece film 20 is a Si oxide film having a thickness of 200 nm.

As illustrated in FIG. 2A, multiple liquid droplets of an acrylic photocurable resin of about 10 pl (picoliters) are dropped onto the workpiece film 20 by an inkjet method. The acrylic photocurable resin becomes the resin film 30.

As described above, the amount of the dropped acrylic photocurable resin determines the residual layer thickness RLT. In this example, the amount of the acrylic photocurable resin is controlled such that the residual layer thickness RLT is 150 nm.

Then, as illustrated in FIG. 2B, the pattern of the first unevenness 41 of the template 40 is transferred onto the surface of the resin film 30 by bringing the transfer surface 40a of the template 40 into contact with the resin film 30. The line-and-space of the first unevenness 41 of the template 40 is 40 nm (i.e., the width of the recess is 40 nm and the width of the protrusion is 40 nm); and the pattern height (the first unevenness depth L1) is 100 nm. At this time, the aspect ratio is 2.5.

Then, for example, the ultraviolet rays 61 are irradiated onto the resin film 30 via the template 40. Thereby, the transfer resin layer 31 having the second unevenness 32 reflecting the configuration of the first unevenness 41 of the template 40 is formed.

Subsequently, as illustrated in FIG. 2C, template separation is performed by separating the template 40 and the transfer resin layer 31.

Then, as illustrated in FIG. 2D, the mask material 50 is filled into the recess 32d of the second unevenness 32 of the transfer resin layer 31 by spin coating SOG onto the transfer resin layer 31 and baking at 300° C. The SOG layer becomes the mask material 50.

Then, etch-back is performed on the SOG layer by RIE to expose the protrusion 32p of the transfer resin layer 31.

Continuing as illustrated in FIG. 3A and FIG. 3B, the transfer resin layer 31 is patterned by RIE with oxygen by using the SOG layer (the mask material 50) as a mask.

Then, as illustrated in FIG. 3C, the exposed workpiece film 20 is patterned using the patterned transfer resin layer 31 as a mask.

Continuing as illustrated in FIG. 3D, the transfer resin layer 31 used as a mask is removed by, for example, ashing using the oxygen plasma 64 and the like.

Thereby, the workpiece film 20 of a silicon oxide film reflecting the unevenness (the first unevenness 41) of the template 40 is obtained with a line-and-space of 40 nm and a pattern height of 200 nm.

According to the patterning method of the first example, the destruction of the template due to particles and the like in the processes is suppressed and a pattern formation having high productivity is possible.

### Second Example

In a pattern formation method of a second example, a photosensitive material is used as the mask material 50. The process of filling the mask material 50 into the recess 32d of the second unevenness 32 of the transfer resin layer 31 will now be described.

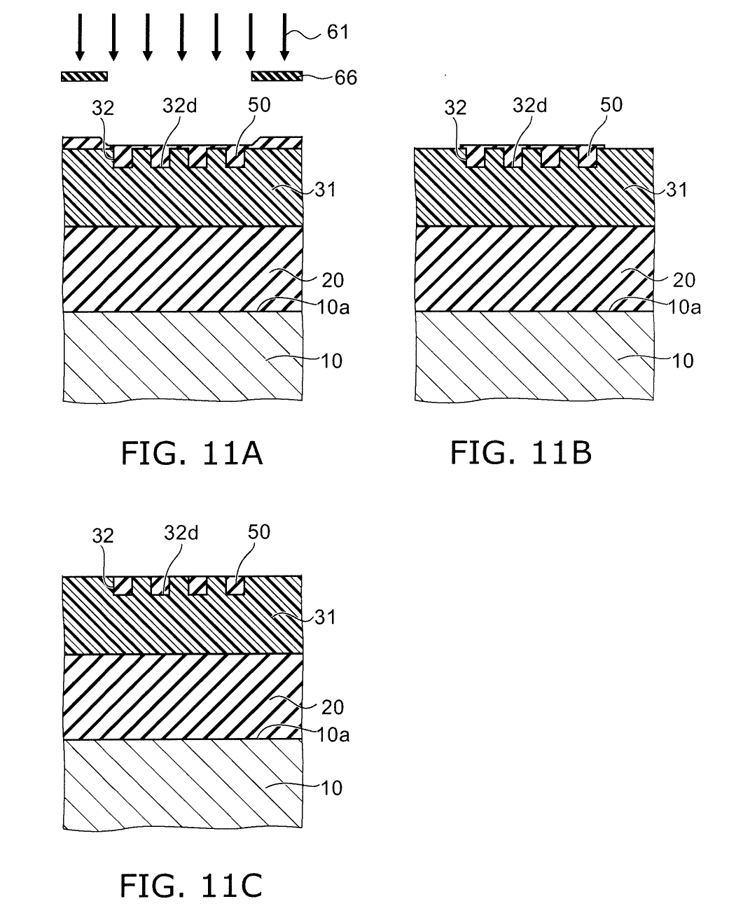

FIGS. 11A to 11C are schematic cross-sectional views illustrating the state of the process of a part of the pattern formation method of the second example.

Namely, FIGS. 11A to 11C illustrate the process of filling the mask material 50 into the recess 32d of the second unevenness 32 of the transfer resin layer 31.

As illustrated in FIG. 11A, a material having a function of being patterned by photolithography is used as the mask material 50. In this example, negative photosensitive SOG is used as the mask material 50. That is, the mask material 50 is photosensitive. A negative photosensitive SOG film spin-coated onto the transfer resin layer 31 is patterned, for example, via a mask 66 using an ArF lithography process.

Thereby, as illustrated in FIG. 11B, the mask material 50 after developing is selectively formed in a region where the recess 32d of the transfer resin layer 31 is formed.

Then, as illustrated in FIG. 11C, etch-back is performed on the negative photosensitive SOG film to form a configuration in which the mask material 50 is filled into the recess 32d of the second unevenness 32 of the transfer resin layer 31.

Thus, by using the photosensitive SOG film as the mask material 50, the SOG film can be formed selectively in the necessary portions; film thickness differences due to, for example, the pattern coverage of the SOG film based on the fineness of the pattern can be reduced; etch-back can be performed more easily; and the productivity can be increased.

### Third Example

In a third example according to this embodiment, the residual layer thickness RLT is determined based on the particle size controlled during the transfer process.

In this example as well as illustrated in FIG. 2A, the workpiece film 20 is formed with a thickness of 200 nm on the major surface 10a of the substrate 10; and multiple liquid droplets of an acrylic photocurable resin of about 10 pl are dropped onto the workpiece film 20 by an inkjet method.

In this example, the residual layer thickness RLT is set such that the residual layer thickness RLT is greater than the sizes (the diameters) of the particles 20p that may exist on the major surface of the substrate 10 during the transfer process. In the case of this example, the minimum value of the particle size controlled in the particle inspection of the transfer process is 150 nm. Based thereon, the amount of the acrylic photocurable resin is controlled such that the residual layer thickness RLT is 150 nm. Thereby, during the transfer process, the damage of the expensive template 40 can be suppressed because the particles 20p can be contained within the residual layer 31r even in the case where particles 20p smaller than 150 nm exist between the workpiece film 20 and the template 40.

Subsequently, similarly to the first example, the transfer resin layer 31 having the second unevenness 32 reflecting the configuration of the first unevenness 41 of the template 40 is formed by bringing the transfer surface 40a of the template 40 into contact with the resin film 30 and irradiating the ultraviolet rays 61 onto the resin film 30; and template separation is performed by separating the template 40 and the transfer resin layer 31.

Then, the mask material 50 is filled into the recess 32d of the second unevenness 32 of the transfer resin layer 31; the transfer resin layer 31 is patterned by RIE using the mask material 50 as a mask; the exposed workpiece film 20 is patterned using the patterned transfer resin layer 31 as a mask; and finally, the transfer resin layer 31 used as the mask is removed.

Thereby, the workpiece film 20 of a silicon oxide film reflecting the unevenness (the first unevenness 41) of the template 40 is formed with a line-and-space of 40 nm and a pattern height of 200 nm.

The patterning method of the third example also can provide a pattern formation method having high productivity in which the destruction of the template due to particles and the like in the processes is suppressed.

As in the second example, a photosensitive resin material (e.g., photosensitive SOG and the like) may be used as the mask material 50 also in the patterning method of the third example to obtain similar effects.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the invention is not limited to these specific examples. For example, one skilled in the art may similarly practice the invention by appropriately selecting specific configurations of components such as templates, processing substrates, transfer materials, light modifying layers, and the like used in pattern formation methods from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all pattern formation methods practicable by an appropriate design modification by one skilled in the art based on the pattern formation methods described above as embodiments of the invention also are within the scope of the invention to the extent that the purport of the invention is included.

Furthermore, various modifications and alterations within the spirit of the invention will be readily apparent to those skilled in the art. All such modifications and alterations should therefore be seen as within the scope of the invention. For example, additions, deletions, or design modifications of components or additions, omissions, or condition modifications of processes appropriately made by one skilled in the art in regard to the embodiments described above are within the scope of the invention to the extent that the purport of the invention is included.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

1. A pattern formation method, comprising:
applying an imprint material onto a workpiece film;
bringing a transfer surface having a first unevenness of a template into contact with the imprint material to form a second unevenness in the imprint material, the second unevenness reflecting a configuration of the first unevenness;
curing the imprint material in a state of the template contacting the imprint material;
filling a mask material into a recess of the second unevenness of the cured imprint material;
exposing a part of the workpiece film by using the filled mask material as a mask to pattern the imprint material; and
patterning the workpiece film by using the patterned imprint material as a mask,
a thickness of the imprint material between the workpiece film and a bottom face of the recess of the second unevenness being not less than 2.5 times a half pitch of the second unevenness.

2. The method according to claim 1, wherein the thickness of the imprint material between the workpiece film and the bottom face of the recess of the second unevenness is greater than a minimum value of a particle size controlled in the bringing the transfer surface into contact with the imprint material.

3. The method according to claim 1, wherein the bringing the transfer surface into contact with the imprint material includes introducing gas existing in the recesses of the first unevenness into the imprint material.

4. The method according to claim 1, wherein the bringing the transfer surface into contact with the imprint material to form the second unevenness includes burying a particle in the imprint material between the workpiece film and the bottom face of the recess of the second unevenness, the particle existing in an atmosphere of the bringing the transfer surface into contact with the imprint material.

5. The method according to claim 1, wherein the workpiece film has a difference of levels and the thickness of the imprint material between the workpiece film and the bottom face of the recess of the second unevenness is larger than a height of the difference of levels.

6. The method according to claim 1, wherein the mask material is photosensitive.

7. The method according to claim 1, wherein the mask material includes SOG (Spin On Glass).

8. The method according to claim 1, wherein an etching rate of the mask material is lower than an etching rate of the cured imprint material.

9. The method according to claim 1, wherein an aspect ratio of the second unevenness is not more than 2.5.

10. The method according to claim 1, wherein the thickness of the imprint material between the workpiece film and the bottom face of the recess of the second unevenness is not less than 50 nanometers.

11. A pattern formation method, comprising:
applying an imprint material onto a workpiece film;
bringing a transfer surface having a first unevenness of a template into contact with the imprint material to form a second unevenness in the imprint material, the second unevenness reflecting a configuration of the first unevenness;
curing the imprint material in a state of the template contacting the imprint material;
filling a mask material into a recess of the second unevenness of the cured imprint material;
exposing a part of the workpiece film by using the filled mask material as a mask to pattern the imprint material; and
patterning the workpiece film by using the patterned imprint material as a mask,
a thickness of the imprint material between the workpiece film and a bottom face of the recess of the second unevenness being greater than a depth of the second unevenness, the depth of the second unevenness being a distance between the bottom face of the recess of the second unevenness and an upper face of a protrusion of the second unevenness.

12. The method according to claim 11, wherein the thickness of the imprint material between the workpiece film and the bottom face of the recess of the second unevenness is greater than a minimum value of a particle size controlled in the bringing the transfer surface into contact with the imprint material.

13. The method according to claim 11, wherein the bringing the transfer surface into contact with the imprint material includes introducing gas existing in the recesses of the first unevenness into the imprint material.

14. The method according to claim 11, wherein the bringing the transfer surface into contact with the imprint material to form the second unevenness includes burying a particle in the imprint material between the workpiece film and the bottom face of the recess of the second unevenness, the particle existing in an atmosphere of the bringing the transfer surface into contact with the imprint material.

15. The method according to claim 11, wherein the workpiece film has a difference of levels and the thickness of the imprint material between the workpiece film and the bottom face of the recess of the second unevenness is larger than a height of the difference of levels.

16. The method according to claim 11, wherein the mask material is photosensitive.

17. The method according to claim 11, wherein the mask material includes SOG (Spin On Glass).

18. The method according to claim 11, wherein an etching rate of the mask material is lower than an etching rate of the cured imprint material.

19. The method according to claim 11, wherein an aspect ratio of the second unevenness is not more than 2.5.

20. The method according to claim 11, wherein the thickness of the imprint material between the workpiece film and the bottom face of the recess of the second unevenness is not less than 50 nanometers.
